(19) United States
(12) Patent Application Publication
(10) Pub. No.: US 2009/0005047 A1
(43) Pub. Date: Jan. 1, 2009

(54) Media independent vertical handovers

(76) Inventors: Vivek Gupta, Portland, OR (US); Sangeetha Bangolae, Beaverton, OR (US)

Correspondence Address: RYDER IP LAW;C/O INTELLEVATE, LLC, P. O. BOX 52050, MINNEAPOLIS, MN, 55402, US

(21) Appl. No.: 11/824,468

(22) Filed: Jun. 29, 2007

(51) Int. Cl. H04Q 7/20

(52) U.S. Cl. 455/437

(57) ABSTRACT

In general, in one aspect, the disclosure describes a method including initiating a network handover between a current network point of attachment (POA) and a mobile mode (MN). Pre-authentication of target network POAs is performed after the MN identifies the target network POAs. One of the target network POAs is selected based at least in part on the pre-authenticating. An IP address is pre-provisioned for MN in the selected target network POA. Communications between the MN and the selected target network POA are established.

### BACKGROUND

Mobile devices (e.g., laptop computers, phones, personal digital assistants (PDA's)) include wireless interfaces so that the user can communicate remotely. Mobile devices may support multiple wireless interfaces (e.g., wireless local area network (WLAN), wireless metropolitan area networks (WMAN)). The mobile devices may switch from one wireless network to another and possibly from one wireless network type to another (e.g., WLAN to WMAN). In order to switch from one network to another the mobile device needs to perform network discovery and selection. Real-time multimedia applications running on a mobile device require the mobile device to quickly establish connection with a new network without interrupting the network service and to maintain the same level of quality of service (QOS) when the mobile device roams from one network to another network.

However, the handoff latency from one network to another may be significant since authentication (performed at the media access control (MAC) layer), Internet Protocol (IP) address assignment (performed at the IP layer), and QOS bandwidth reservation (e.g., voice, video) performed in the application layer or network layer are required to successfully complete the handoff.

### BRIEF DESCRIPTION OF THE DRAWINGS

The features and advantages of the various embodiments will become apparent from the following detailed description in which:

FIG. 1 illustrates an example flow diagram of a network initiated handover, according to one embodiment; and

FIG. 2 illustrates an example flow diagram of a mobile node (MN) initiated handover, according to one embodiment.

### DETAILED DESCRIPTION

Various different types of wireless networks exist including wireless local area networks (WLAN), such as networks that are compliant with the Institute of Electrical and Electronic Engineers (IEEE) standard 802.11.x (Wi-Fi networks), wireless metropolitan networks (WMAN), such as networks that are compliant with the IEEE standard 802.16.x (WiMAX networks) and other third generation high-speed wireless access networks, such as those that are compliant with the 3rd Generation Partnership Project (3GPP/3GPP2) standards TR 23.882, TR 22.937, and TR 22.811 (3G networks). Mobile devices (referred to as mobile nodes (MN)) may include various wireless interfaces so that they can communicate with the various network types. The MN may communicate with base stations and access points (referred to as points of attachment (POA)) that make up the wireless networks. As the wireless networks may overlap with one another, the MN may switch from one various wireless network (and possibility different wireless network types) to another while stationary or as the MN moves. The wireless network that the MN communicates with may be based on various parameters including location (network availability), quality of service (QOS) requirements of the application running on the MN, and network capacity.

The MN may switch from one wireless network to another wireless network (possibly to a different wireless network type) for various reasons including, but not limited to changes in location, changes in QOS parameters, and changes in network capacity. The switching of wireless networks used to communicate with the MN may be initiated by the MN or the POA. The handover of the MN from one wireless network to another needs to be efficient to avoid interrupting the network service. Handover latency may be caused by the need for the MN and the new wireless network to perform authentication, IP assignment and bandwidth reservations.

The MN may utilize and possibly collaborate with the current wireless network to expedite the handover process. The MN may know what wireless networks are available (target networks) but may not know if these target networks can support (e.g., has sufficient bandwidth) the current QOS parameters of applications running on the MN. The current network may be able to gather this information from the target networks using backend communications (wired links) quicker then the MN could query each of the wireless networks and accordingly saves wireless network resources and expedite the handover.

The MN may provide details regarding the type of resources it needs for currently running applications (the QOS parameters) to the current wireless network during a handoff initiation sequence and the current network may query the target networks to determine which target network can meet these parameters. The MN may provide the QOS parameters (e.g., minimum data rate, mean data rate, peak data rate, delay bound, minimum PHY rate) to the current network in the form of resource reservation request/query and the current network may query the target networks to determine which ones can satisfy these resource reservations.

The current network may also transfer client specific context information related to the MN to target networks for pre-authentication during the handoff initiation sequence. Accordingly, the MN could be pre-authenticated to multiple target networks and choose the target network to move to based on QOS and other criteria. If the MN was pre-authenticated with the target network before the handover actually occurred the handover process could be significantly reduced since the delays due to authentication being part of the handover process would be minimized.

Once a target network is selected, the current network may inform the target network selected that it has been selected prior to the actual handoff occurring. The selected target network can then pre-provision an Internet Protocol (IP) address over the backend network prior to actual hand-off. When the handover to the target network is complete the MN can obtain the IP address without the IP address acquisition being a significant part of the hand-off process.

A set of handover commands (initiate, prepare, commit and complete) for heterogeneous/vertical handovers may be utilized to implement resource reservations, pre-authentication and IP addressing preparation described above. The set of handover commands can be initiated either by the client or the network and can conduct both client-initiated and network-initiated handovers. The commands are media-independent and the payload defined by these commands can be transported over different access networks (wireless and wired). Each of the commands includes a request and a response. All of the commands will include source ID and destination ID to identify the sender and receiver of the command.

An handover initiate request command initiates the handover process and can be initiated by the wireless network or the MN. In addition to source ID and destination ID, the command may also include the current link ID, a list of suggested new links, a list of suggested new POAs associated with the new links, handover mode requested, a list of actions occurring on the old link, and a list of resources (QOS parameters) that should be queried (query resource list).

An handover initiate response command is generated in response to the initiate request. The command may include the current link ID, an acknowledgement of the handover, a list of preferred links, a list or preferred POAs for the preferred links, an abort reason if the handover is aborted, and a list of available resources (QOS parameters).

If the request is initiated by the network, the response from the MN may either keep the link/POA lists provided or may provide different lists.

A handover prepare request command is sent from the POA for the current wireless network to one or several target networks. The command may include the query resource list (QOS parameters desired), and client context data (credentials of the MN). The context data is used by the target POA for pre-authentication (security).

A handover prepare response command is generated in response from the target networks. The command may include resource status (whether the network is available) and a list of available resources (QOS parameters available).

A target network may be selected based on the handover prepare responses from the various target networks. The selection of the network may be a collaboration between the MN and the current POA. The collaboration may entail the exchange of several handover initiate request/response commands therebetween.

A handover commit request command is initiated to confirm that the handover is to occur. The command may include current link ID, new link ID, MAC address of new POA, and list of actions occurring on the old link. The current POA will send this message to the selected POA to ensure the selected POA is ready to assume control once the MN agrees to the handover. The new POA may use this command to begin pre-provisioning an IP address. The MN or the current POA may send the message to the other depending on who initiated the switching.

A handover commit response command is generated in response to the handover commit request. The command may include list of actions on current link, list of actions on old link, and a handover status (e.g., 1 indication the handover was successful. These commands are sent from the target POA to the current POA and may be sent from the MN or current POA to the other.

A handover complete request command is initiated to request confirmation that the transfer is complete. A handover complete response command is generated in response thereto. Both the handover complete request/response commands may include the current link ID (the link that communications was transferred to).

The handover complete request/response commands are exchanged between the MN and the new POA (target POA) and the previously serving POA and the new POA.

The content of the commands is not limited by that disclosed above. Rather content can be added or removed from the commands without departing from the scope as long as the commands are media independent (can be generated, transmitted, received, and/or processed by various devises and be communicated between devices over various networks, whether wireless or wired) and can utilize a backend network (wired network connecting POAs) in the handover process to free up wireless resources and improve handover latency.

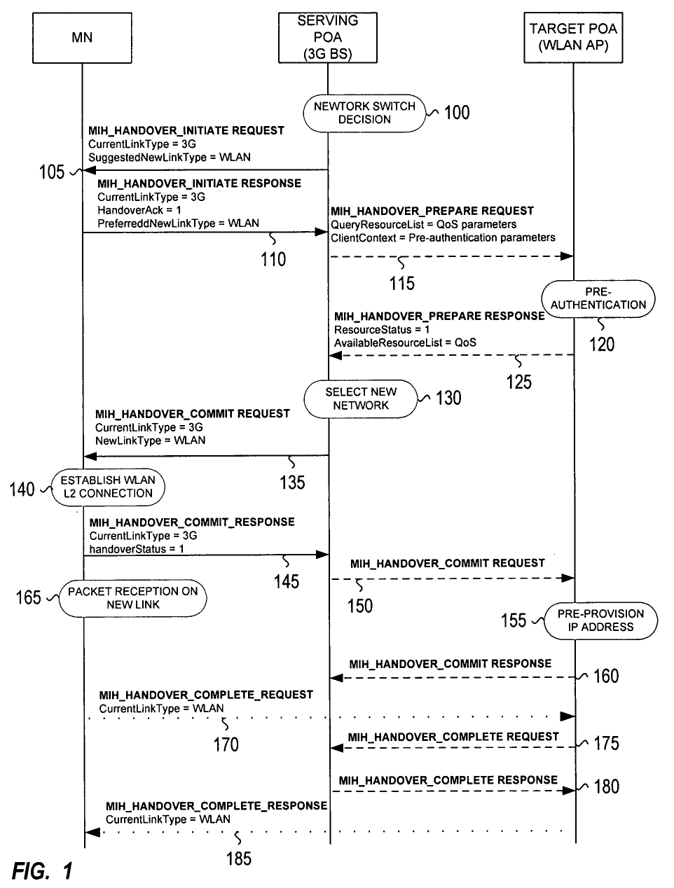

FIG. 1 illustrates an example flow diagram of a network initiated handover. The current wireless network is a 3G network and the POA is base station (3G BS). The 3G BS determines that the MN should be handed off to a new network 100. The reason for the handover decision 100 may include load balancing, QOS parameters, or network availability. For example, if the network operator supports several networks (e.g., 3G and WLAN) the operator may determine for load balancing purposes that the MN should be switched from one network type to another (3G to WLAN). The 3G BS may be aware that the MN can communicate with a WLAN via an access point (WLAN AP) (the WLAN AP is a target POA) because the MN may send link detected indications to the current POA when it detects other POAs are available to it (are target POAs). It should be noted that multiple target networks and multiple POAs may be available but that only a single one (WLAN AP) is included in FIG. 1 for ease of illustration and all of the messages only address the single target POA.

The current POA (3G BS) initiates the handover by generating and transmitting a handover initiate request 105 to the MN with a list of suggested new links (network connections) and a list of suggested addresses for the target POAs. The MN responds with a handover initiate response 110 that acknowledges the initiate request 105 and identifies the new links that it prefers.

When the 3G BS receives the handover initiate response from the MN, it generates and transmits handover prepare requests 115 to each of the preferred POAs identified. The requests 115 identify QOS parameters required/desired by the MN so that the POA can make a determination as to whether it can satisfy these QOS parameters. The target POAs generate and transmit a handover prepare response 125 to the 3G BS that identifies if the network is available and provides the available QOS parameters. The request 115 to the target POAs also includes client context data that the target POAs use to pre-authenticate the MN to the network 120.

Once the network receives the responses 125 a determination is made as to which target POA the MN should be handed off to 130. The decision may be a collaboration between the 3G BS and the MN and the collaboration may entail the exchange of handover initiate requests/response between the two (not illustrated). Once the target POA (WLAN AP) is selected the 3G BS generates and transmits a handover commit request 135 to the MN. The MN establishes a secondary connection with the selected target POA (WLAN AP) 140 and then generates and transmits a handover commit response 145 to the 3G BS. When the 3G BS receives the commit response from the MN 145, it generates and transmits a commit request 150 to the WLAN AP. The WLAN AP begins pre-provisioning of an IP address 155. The WLAN AP generates and transmits the commit response 160 to the 3G BS. The MN attempts to receive packets over the new link 165. Once the packets are received, the MN generates and transmits a handover complete request 170 to the WLAN AP. The WLAN AP exchanges handover complete requests and responses 175, 180 with the 3G BS. The WLAN AP then generates and transmits a handover complete response 185 to the MN to conclude the handover.

The order in which the commands are transmitted between devices is not limited to the illustrated order. Rather, the order of the commands can be modified without departing from the current scope. For example, the handover commit request/response commands between the 3G BS and WLAN AP could occur after the new network is selected 130, or after the handover commit request 135 is sent from the 3G BS, rather then waiting for the handover commit response 145 from the MN as the 3G BS would know the transfer was approved at those points. Moving these commands earlier in the cycle could provide the IP pre-provisioning 155 earlier and thus decrease the handover latency.

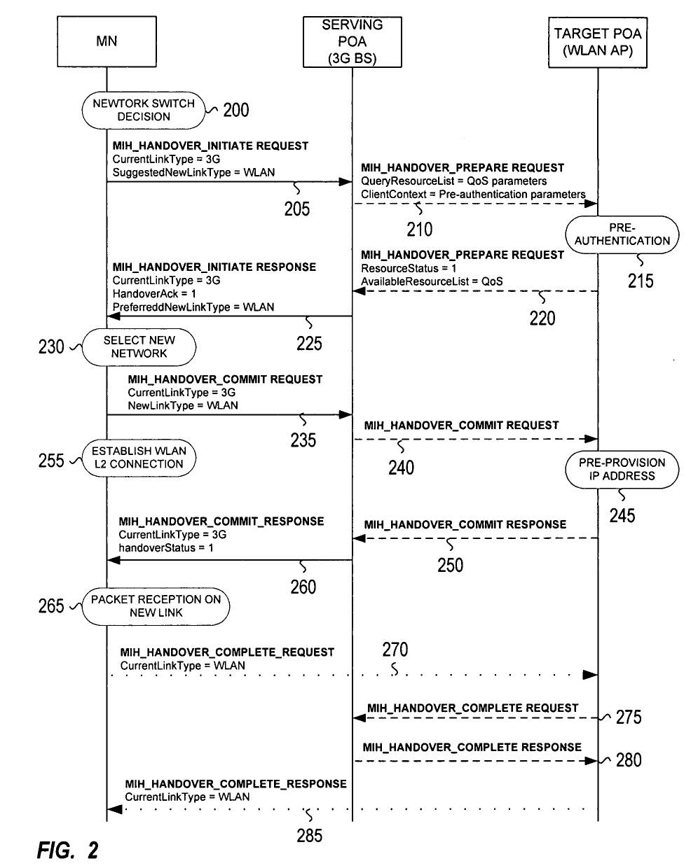

FIG. 2 illustrates an example flow diagram of a MN initiated handover. The current wireless network is a 3G network and the POA is base station (3G BS). The MN determines that it be handed off to a new network 200. The reason for the handover decision 200 may include load balancing, QOS parameters, or network availability. For example, the MN may receive a message that the link to the 3G BS is going down. The MN may be aware of other networks that available based on detecting signals from these networks. The MN initiates the handover by generating and transmitting a handover initiate request 205 to the 3G BS with a list of suggested new links (network connections) and a list of suggested addresses for the target POAs. It should be noted that multiple target networks and multiple POAs may be available but that only a single one (WLAN AP) is included in FIG. 1 for ease of illustration and all of the messages only address the single target POA.

When the 3G BS receives the handover initiate request from the MN, it generates and transmits handover prepare requests 210 to each of the preferred POAs identified. The target POAs generate and transmit a handover prepare response 220 to the 3G BS that identifies if the network is available and provides the available QOS parameters. The request 210 to the target POAs also includes client context data that the target POAs use to pre-authenticate the MN to the network 215.

Once the 3G BS receives the handover prepare responses 220 from the target POAs, it generates and transmits a handover initiate response 225 that acknowledges the initiate request 205 and identifies the new links that it believes are preferable based on the prepare responses 220. Once the MN receives the response 225 a determination is made as to which target POA the MN should be handed off to 230. The decision may be a collaboration between the 3G BS and the MN and the collaboration may entail the exchange of handover initiate requests/response between the two (not illustrated). Once the target POA (WLAN AP) is selected the MN generates and transmits a handover commit request 235 to the 3G BS. After sending the commit request 235, the MN establishes a secondary connection with the selected target POA (WLAN AP) 255. The 3G BS generates and transmits a commit request 240 to the WLAN AP. The WLAN AP begins pre-provisioning of an IP address 245. The WLAN AP generates and transmits the commit response 250 to the 3G BS. The 3G BS generates and transmits a commit response 260 to the MN.

The MN attempts to receive packets over the new link 265. Once the packets are received, the MN generates and transmits a handover complete request 270 to the WLAN AP. The WLAN AP exchanges handover complete requests and responses 275, 280 with the 3G BS. The WLAN AP then generates and transmits a handover complete response 285 to the MN to conclude the handover.

The order in which the commands are transmitted between devices is not limited to the illustrated order. Rather, the order of the commands can be modified without departing from the current scope.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed:

1. A method comprising
initiating a network handover between a current network point of attachment (POA) and a mobile mode (MN);
pre-authenticating target network POAs after the MN identifies the target network POAs in the initiating;
selecting one of the target network POAs based at least in part on the pre-authenticating;
pre-provisioning IP address for MN in the selected target network POA; and
establishing communications between the MN and the selected target network POA.

2. The method of claim 1, wherein the initiating includes exchanging messages between the MN and the current network POA, wherein the messages include
a handover initiate request identifying suggested target network POAs, and
a handover initiate response identifying preferred target network POAs in response to the initiate request.

3. The method of claim 2, wherein the handover initiate request is prepared by the MN and the handover initiate response is prepared by the current network POA.

4. The method of claim 3, wherein the current network POA determines preferred target POAs based at least in part on the pre-authenticating.

5. The method of claim 2, wherein the handover initiate request is prepared by the current network POA and the handover initiate response is prepared by the MN.

6. The method of claim 1, wherein the pre-authenticating includes
preparing a handover prepare request identifying desired quality of service (QOS) parameters and client context data;
transmitting the handover prepare request from the current network POA to identified target network POAs, wherein the client context data is utilized by the target network POAs for pre-authentication; and
receiving handover prepare responses from the identified target network POAs in response to the handover prepare request, wherein the handover prepare response identifies target network POA available QOS parameters.

7. The method of claim 1, wherein the pre-provisioning includes preparing and transmitting a handover commit request from the current network POA to the selected target network, wherein the selected network POA being to acquire an IP address based thereon.
